(19) United States
(12) Patent Application Publication
(10) Pub. No.: US 2026/0050282 A1
(43) Pub. Date: Feb. 19, 2026

(54) LOW-DROPOUT REGULATOR

(71) Applicant: Realtek Semiconductor Corp., HsinChu (TW)

(72) Inventor: Chen-Yi Kuo, HsinChu (TW)

(73) Assignee: Realtek Semiconductor Corp., HsinChu (TW)

(21) Appl. No.: 19/294,223

(22) Filed: Aug. 7, 2025

(30) Foreign Application Priority Data
Aug. 16, 2024 (TW) 113130786

(51) Int. Cl. G05F 1/575

(52) U.S. Cl. CPC G05F 1/575

(57) ABSTRACT

The present invention provides a LDO including an operational amplifier, a first transistor and a buffer. The operational amplifier is configured to receive a reference voltage and a feedback voltage to generate a control signal. A gate electrode of the first transistor receives the control signal, a first electrode of the first transistor is coupled to a supply voltage, and a second electrode of the first transistor is coupled to a node, wherein the node is used to generate an output voltage of the LDO. An input terminal of the buffer is connected to a bias voltage, and an output terminal of the buffer is connected to the node.

### BACKGROUND OF THE INVENTION

### 1. Field of the Invention

The present invention relates to a low-dropout regulator.

### 2. Description of the Prior Art

Generally, a low-dropout regulator (LDO) typically has two poles in its frequency response, and these two poles need to be significantly different in frequency, for example, more than ten times difference in frequency, to ensure the stability of the LDO. To ensure stability, the LDO sometimes use an N-type transistor as the power transistor at the output stage. If P-type transistor is used as the power transistor at the output stage, resistors may be placed in series with the output capacitor of the LDO. However, using the N-type transistor as the power transistor at the output stage increases additional power consumption, and placing resistors in series with the output capacitor may degrade load regulation and transient response.

### SUMMARY OF THE INVENTION

Therefore, one of the objectives of the present invention is to provide a LDO that has lower power consumption and does not adversely affect the load regulation and transient response of the LDO, while ensuring the stability of the LDO and addressing the problems described in the prior art.

According to one embodiment of the present invention, a LDO comprising an operational amplifier, a first transistor and a buffer is disclosed. The operational amplifier is configured to receive a reference voltage and a feedback voltage to generate a control signal. A gate electrode of the first transistor receives the control signal, a first electrode of the first transistor is coupled to a supply voltage, and a second electrode of the first transistor is coupled to a node, wherein the node is used to generate an output voltage of the LDO. An input terminal of the buffer is connected to a bias voltage, and an output terminal of the buffer is connected to the node.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram of a LDO according to an embodiment of the present invention.

FIG. 2 is a schematic diagram of a LDO according to an embodiment of the present invention.

FIG. 3 shows the impact on the LDO after adding the buffer.

### DETAILED DESCRIPTION

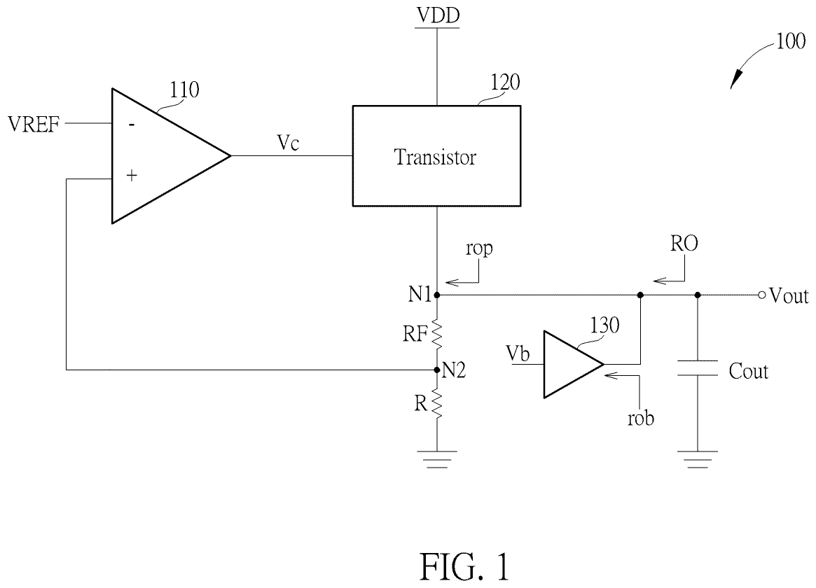

FIG. 1 is a schematic diagram of a LDO 100 according to an embodiment of the present invention, where the LDO 100 is used to receive a reference voltage VREF to generate an output voltage Vout. As shown in FIG. 1, the LDO 100 includes an operational amplifier 110, a transistor 120, a buffer 130, a resistor RF, a resistor R, and an output capacitor Cout. In this embodiment, the operational amplifier 110 can have any suitable type, such as a 5-transistor amplifier, a telescopic amplifier, a folded cascode amplifier, etc. One input terminal of the operational amplifier 110 is connected to the reference voltage VREF, another input terminal is connected to a node N2, and an output terminal is connected to the transistor 120. The transistor 120 can be an N-type transistor or a P-type transistor, such as an N-type or P-type Metal-Oxide-Semiconductor Field-Effect Transistor (MOSFET), where the gate electrode, a first electrode and a second electrode of the transistor 120 are connected to the output terminal of the operational amplifier 110, a supply voltage VDD and a node N1 (which is used to generate the output voltage Vout), respectively. The resistor RF is connected between nodes N1 and N2, and the resistor R is connected between node N2 and a ground voltage. An input terminal of the buffer 130 is connected to a fixed bias voltage Vb, and an output terminal is connected to the node N1. A first terminal of the output capacitor Cout is connected to the node N1, and a second terminal is connected to the ground voltage.

In the LDO 100 shown in FIG. 1, the operational amplifier 110 receives the reference voltage VREF and a feedback voltage from node N2 to generate a control signal Vc to the transistor 120. This controls the current through the transistor 120 to achieve a stable output voltage Vout. In the circuit architecture of the LDO 100, there are two poles: the first pole is at the output terminal of the operational amplifier 110, and the second pole is at the output terminal of the LDO 100. To increase the frequency difference between the second pole and the first pole to ensure the stability of the LDO 100, this embodiment designs the buffer 130 with low output impedance characteristics to reduce the output impedance of the LDO 100 and push the second pole to a higher frequency. For example, in FIG. 1, if the output impedance of the transistor 120 in parallel with the resistors RF and R is denoted as “rop,” and the output impedance of the buffer 130 is denoted as “rob,” then the output impedance “RO” of the LDO 100 will be the result of “rop” in parallel with “rob.” Furthermore, since the output impedance “rob” of the buffer 130 is much smaller than the output impedance “rop” of the transistor 120 in parallel with the resistors RF and R, the output impedance “RO” of the LDO 100 will be approximately equal to the output impedance “rob” of the buffer 130. The frequency of the second pole can be expressed as follows:

$$ω p 2 \approx \frac{1}{r o b * Cout} . \qquad ( 1 )$$

As shown in Equation (1), because the buffer 130 has very low output impedance “rob,” the second pole of the LDO 100 will have a higher frequency. This results in a large frequency difference between the two poles of the LDO 100, thereby increasing the overall stability of the circuit operation.

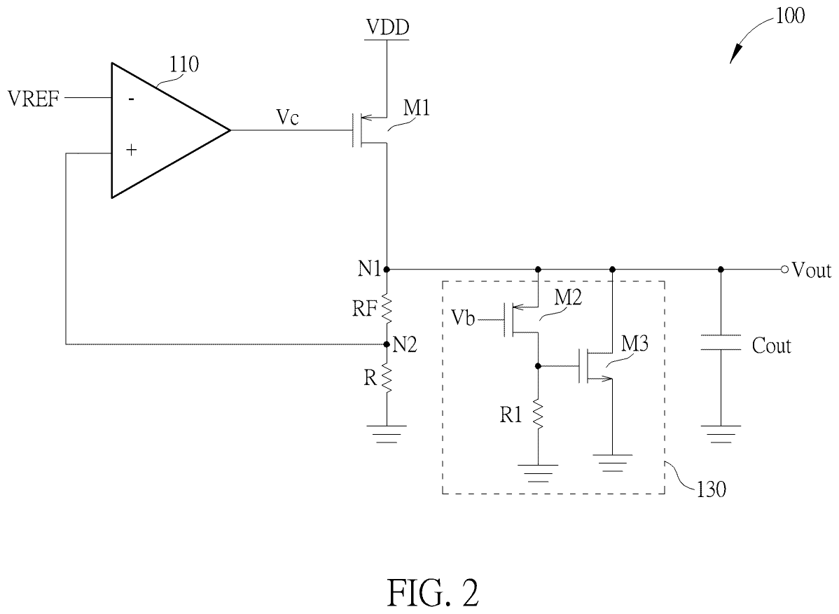

In one embodiment, referring to FIG. 2, the transistor 120 of the LDO 100 is implemented by a P-type transistor M1, where a source electrode of the P-type transistor M1 is connected to the supply voltage VDD, and a drain electrode of the P-type transistor M1 is connected to the node N1. Compared to the N-type transistor, using the P-type transistor M1 allows the operational amplifier 110 to generate a lower voltage control signal Vc to drive the P-type transistor M1, thereby reducing the power consumption of the LDO 100. Additionally, since the P-type transistor M1 has higher output impedance, the lower output impedance “rob” provided by the buffer 130 can prevent the issue of excessive output impedance “RO” in the LDO 100 due to the use of the P-type transistor M1.

In one embodiment, referring to FIG. 2, the buffer 130 is implemented by using a source follower, which includes a P-type transistor M2, a resistor R1, and an N-type transistor M3. The gate electrode, source electrode, and drain electrode of the P-type transistor M2 are connected to a bias voltage Vb, the node N1 and a first terminal of the resistor R1, respectively. A second terminal of the resistor R1 is connected to a reference voltage (which is a ground voltage in this embodiment). The gate electrode of the N-type transistor M3 is connected to the drain electrode of the P-type transistor M2, and the drain electrode and source electrode of the N-type transistor M3 are connected to the node N1 and ground voltage, respectively. In this embodiment shown in FIG. 2, the output impedance “rob” of the buffer 130 can be expressed as follows:

$$r o b \approx \frac{1 + R 1 / ro 1}{g m 1 + g m 1 * g m 2 * R 1} ; \qquad ( 2 )$$

where “gm1” is the transconductance of the P-type transistor M2, “gm2” is the transconductance of the N-type transistor M3, and “ro1” is the impedance of the P-type transistor M2. Since the output impedance “rob” of the buffer 130 in Equation (2) is very small, it effectively reduces the output impedance “RO” of the LDO 100, thereby increasing the frequency of the second pole.

In another embodiment, the transistors M2 and M3 shown in FIG. 2 are not limited to being a P-type transistor and an N-type transistor, respectively. That is, as long as the gate electrode, first electrode, and second electrode of transistor M2 are connected to the bias voltage Vb, the node N1 and a reference voltage, respectively, and the first electrode and second electrode of the transistor M3 are connected to the node N1 and the reference voltage, respectively, such design variations fall within the scope of the present invention. For example, if the transistors M2 and M3 in FIG. 2 are implemented by N-type and P-type transistors, respectively, then the lower end of resistor R1 can be connected to the supply voltage VDD, and the drain electrode and source electrode of the transistor M3 will be connected to the node N1 and the supply voltage VDD, respectively.

It should be noted that the buffer 130 shown in FIG. 2 is merely an illustrative example and is not a limitation of the present invention. In other embodiments, the resistor R1 and the N-type transistor M3 may be removed from the buffer 130. In this case, the output impedance “rob” of the buffer 130 can be expressed as follows:

$$rob \approx \frac{1}{g m 1} . \qquad ( 3 )$$

In one embodiment, to avoid affecting the load regulation and transient response of the LDO 100, no resistor is intentionally placed between the output capacitor Cout and node N1. That is, the first terminal of the output capacitor Cout is directly connected to node N1.

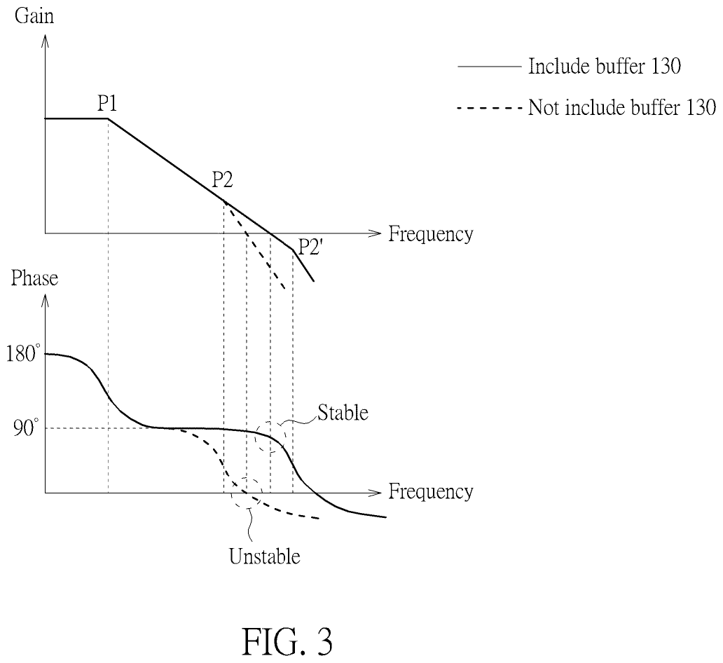

FIG. 3 shows the impact on the LDO 100 after adding the buffer 130, as compared to FIG. 1 and FIG. 2. As shown in FIG. 3, if the LDO 100 does not include the buffer 130, the frequency difference between the second pole p2 and the first pole p1 will be relatively small, which may cause the system to become unstable. However, if the LDO 100 includes the buffer 130, the frequency difference between the second pole p2′ and the first pole p1 will be larger, thereby stabilizing the operation of the LDO 100.

In summary, by adding a buffer with low output impedance at the output stage of the LDO, the overall output impedance of the LDO can be effectively reduced, thereby increasing the frequency difference between the two poles of the LDO and enhancing the overall stability of the circuit operation.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A low-dropout regulator (LDO), comprising:
an operational amplifier, configured to receive a reference voltage and a feedback voltage to generate a control signal;
a first transistor, wherein a gate electrode of the first transistor receives the control signal, a first electrode of the first transistor is coupled to a supply voltage, and a second electrode of the first transistor is coupled to a node, wherein the node is used to generate an output voltage of the LDO; and
a buffer, wherein an input terminal of the buffer is connected to a bias voltage, and an output terminal of the buffer is connected to the node.

2. The LDO of claim 1, wherein the buffer is a source follower.

3. The LDO of claim 1, wherein the first transistor is a P-type transistor, a source electrode of the first transistor is coupled to the supply voltage, and a drain electrode of the first transistor is coupled to the node.

4. The LDO of claim 3, wherein the buffer is a source follower.

5. The LDO of claim 4, wherein the buffer comprises:
a second transistor, wherein a gate electrode, a first electrode and a second electrode of the second transistor are coupled to the bias voltage, the node and a reference voltage, respectively.

6. The LDO of claim 5, wherein the reference voltage is a ground voltage, the second transistor is a P-type transistor, and a source electrode and a drain electrode of the second transistor are coupled to the node and the ground voltage, respectively.

7. The LDO of claim 5, wherein the buffer further comprises:
a resistor, wherein a first terminal of the resistor is coupled to the second electrode of the second transistor, and a second terminal of the resistor is coupled to the reference voltage; and
a third transistor, wherein a gate electrode of the third transistor is coupled to the second electrode of the second transistor, and a first electrode and a second electrode of the third transistor are coupled to the node and the reference voltage, respectively.

8. The LDO of claim 7, wherein the second transistor is a P-type transistor, and a source electrode and a drain electrode of the second transistor are coupled to the node and the first terminal of the resistor, respectively.

9. The LDO of claim 8, wherein the reference voltage is a ground voltage, the first terminal of the resistor is coupled to the drain electrode of the second transistor, and the second terminal of the resistor is coupled to the ground voltage.

10. The LDO of claim 8, wherein the reference voltage is a ground voltage, the third transistor is an N-type transistor, and a drain electrode and a source electrode of the third transistor are coupled to the node and the ground voltage.
